(19) United States
(12) Patent Application Publication
(10) Pub. No.: US 2017/0121785 A1
(43) Pub. Date: May 4, 2017

(54) PRIMARY RECRYSTALLIZATION ANNEALED SHEET FOR GRAIN-ORIENTED ELECTRICAL STEEL SHEET PRODUCTION, AND METHOD OF PRODUCING GRAIN-ORIENTED ELECTRICAL STEEL SHEET

(71) Applicant: JFE Steel Corporation, Tokyo (JP)

(72) Inventors: Yukihiro Shingaki, Tokyo (JP); Yuiko Wakisaka, Tokyo (JP); Hirotaka Inoue, Tokyo (JP)

(21) Appl. No.: 15/128,451

(22) PCT Filed: Mar. 26, 2015
(86) PCT No.: PCT/JP2015/060406

§ 371 Date: Sep. 23, 2016

(30) Foreign Application Priority Data
Mar. 31, 2014 (JP) 2014-073983

(51) Int. Cl. C21D 9/46; C21D 1/26; C23C 8/26; C23C 8/50; C22C 38/60; C22C 38/40; C22C 38/34; C22C 38/16; C22C 38/12; C22C 38/08; C22C 38/06; C22C 38/04; C22C 38/02; C22C 38/00; H01F 1/16; C21D 6/00

(52) U.S. Cl. CPC C21D 9/46; C21D 6/004; C21D 6/005; C21D 6/008; C21D 1/26; C23C 8/26; C23C 8/50; C22C 38/60; C22C 38/40; C22C 38/34; C22C 38/16; C22C 38/12; C22C 38/08; C22C 38/06; C22C 38/04; C22C 38/02; C22C 38/008; C22C 38/002; C22C 38/001; H01F 1/16; C21D 2201/05

(57) ABSTRACT

A primary recrystallization annealed sheet obtainable after an intermediate step of nitriding treatment in a grain-oriented electrical steel sheet production process using, as a material, a steel slab contains, in mass %, 0.001% to 0.10% of C, 1.0% to 5.0% of Si, 0.01% to 0.5% of Mn, 0.002% to 0.040% of one or two selected from S and Se, 0.001% to 0.050% of sol.Al, and 0.0010% to 0.020% of N, the remainder being Fe and incidental impurities. A nitrogen increase ΔN due to the nitriding treatment is 1000 ppm or less, and N intensity according to X-ray fluorescence at the steel sheet surface is 0.59 or greater. As a result, uniform sheet thickness direction dispersion of nitrides as inhibitors can be achieved with industrial reliability in a grain-oriented electrical steel sheet production process including nitriding, thereby enabling reliable production of grain-oriented electrical steel sheets having good magnetic properties.

### TECHNICAL FIELD

This disclosure relates to a primary recrystallization annealed sheet for grain-oriented electrical steel sheet production that is suitable for production of a grain-oriented electrical steel sheet and to a grain-oriented electrical steel sheet production method through which grain-oriented electrical steel sheets having excellent magnetic properties can be cheaply obtained using primary recrystallization annealed sheets such as that described.

### BACKGROUND

A grain-oriented electrical steel sheet is a soft magnetic material used as an iron core material of transformers, generators and the like, and has a crystal microstructure in which the <001> orientation, which is an easy magnetization axis of iron, is highly accorded with the rolling direction of the steel sheet. Such crystal microstructure is formed through secondary recrystallization where coarse crystal grains with (110)[001] orientation, the so-called Goss orientation, grow preferentially during secondary recrystallization annealing in the production process of the grain-oriented electrical steel sheet.

Conventionally, such grain-oriented electrical steel sheets are produced by heating a slab containing around 4.5 mass % or less of Si and inhibitor components such as MnS, MnSe, and AlN to 1300° C. or higher to temporarily dissolve the inhibitor components, subsequently subjecting the slab to hot rolling and also hot band annealing as necessary, subsequently performing cold rolling once or twice or more with intermediate annealing performed therebetween until reaching final sheet thickness, subsequently subjecting the steel sheet to primary recrystallization annealing in a wet hydrogen atmosphere for primary recrystallization and decarburization and, subsequently, applying an annealing separator mainly composed of magnesia (MgO) thereon and performing final annealing at 1200° C. for around 5 hours for secondary recrystallization and purification of inhibitor components (for example, U.S. Pat. No. 1,965,559 A, JP S40-15644 B, and JP S51-13469 B).

As mentioned above, in the conventional production processes of grain-oriented electrical steel sheets, precipitates such as MnS, MnSe and AlN precipitates (inhibitor components) are contained in a slab, which is then heated at a high temperature exceeding 1300° C. to temporarily dissolve these inhibitor components and, in the following process, the inhibitor components are finely precipitated to develop secondary recrystallization. As described above, in the conventional production processes of grain-oriented electrical steel sheets, since slab heating at a high temperature exceeding 1300° C. was required, significantly high production costs were inevitable and therefore recent demands of reduction in production costs could not be met.

To solve the above problem, for example, JP 2782086 B proposes a method including preparing a slab containing 0.010% to 0.060% of acid-soluble Al (sol.Al), heating the slab at a low temperature and performing nitridation in an appropriate nitriding atmosphere during a decarburization annealing process to use precipitated (Al,Si)N as an inhibitor during secondary recrystallization. (Al,Si)N finely disperses in steel and serves as an effective inhibitor. However, since inhibitor strength is determined by the content of Al, a sufficient grain growth inhibiting effect was not always obtained when the hitting accuracy of Al amount during steelmaking was insufficient. Many methods similar to the above where nitriding treatment is performed during intermediate process steps and (Al,Si)N or AlN is used as an inhibitor have been proposed and, recently, production methods where the slab heating temperature exceeds 1300° C. have also been disclosed.

It is known that in such nitriding techniques, nitrogen is not uniformly present in steel in a sheet thickness direction straight after nitriding and is caused to diffuse through a secondary recrystallization annealing process (final annealing process) such that nitrides precipitate uniformly in the sheet thickness direction (Y. Ushigami et al., Materials Science Forum, Vols. 204-206 (1996), pp 593-598).

JP H4-235222 A discloses a technique that causes uniform formation of nitrides in the sheet thickness direction by holding at a temperature of 700° C. to 800° C. for 4 hours during final annealing to promote nitrogen diffusion and form Al-containing nitrides. Straight after nitriding in those methods, α-Si₃N₄ precipitates randomly within crystal grains and at grain boundaries in a layer spanning approximately ¼ of the sheet thickness from the surface. When Si₃N₄ is maintained at a high temperature, it is replaced by more thermodynamically stable AlN or (Al,Si)N. In that situation, a uniform nitride state in the sheet thickness direction is realized.

As has been explained above, it is important that an inhibitor is uniformly dispersed in the steel. When AlN or Al,Si)N is used as an inhibitor, a uniform dispersed state thereof is achieved by taking advantage of the thermodynamic instability of Si₃N₄ relative to Al-containing nitrides. However, Si₃N₄ is a more thermodynamically stable precipitate than, for example, iron-based nitrides and even in a situation in which Si₃N₄ is replaced by a more stable Al-containing nitride as described, for example, in JP '222, it is difficult to cause diffusion of nitrogen in the steel without heating to a temperature of roughly 700° C. or higher. Therefore, it is difficult to cause completely uniform precipitation in the sheet thickness direction when a heating pattern suitable for nitrogen diffusion cannot be adopted due to restrictions such as furnace structure and shortening of secondary recrystallization annealing time.

In some cases, the Si₃N₄ itself, which does not contain Al, is used as an inhibitor. When a normal nitriding method is used, Si₃N₄ precipitates in a ¼ layer from the surface as pre-viously explained. The function of an inhibitor can be achieved to a certain extent using Si₃N₄, even though the Si₃N₄ is not distributed uniformly in the sheet thickness direction. However, in contrast to when Al-containing precipitates are used, once Si₃N₄ has precipitated, dissolution treatment and re-precipitation are required to homogenize the dispersion state of Si₃N₄, which makes it difficult to achieve homogenization in secondary recrystallization annealing.

The issue of how to cause diffusion of nitrogen in the sheet thickness direction and implement uniform precipitation, both in situations in which Al-containing precipitates are used and in situations in which non-Al-containing precipitates are used, is of great technical importance to production of grain-oriented electrical steel sheets. As a result, there may be restrictions on the heating pattern during secondary recrystallization annealing when Al is used, whereas it may be difficult to even implement uniform precipitation when Al is not used.

As explained above, although numerous production methods have been proposed with the objective of achieving uniform precipitation of nitrides in steel when producing a grain-oriented electrical steel sheet through a method in which nitriding is adopted, it has still been difficult to simply form a uniform precipitation state in the sheet thickness direction of a steel sheet using any of these methods.

### SUMMARY

We thus provide:
1. A primary recrystallization annealed sheet for grain-oriented electrical steel sheet production, the primary recrystallization annealed sheet being obtainable after nitriding treatment in a series of steps for grain-oriented electrical steel sheet production in which a steel slab containing (consisting of), in mass %, 0.001% to 0.10% of C, 1.0% to 5.0% of Si, 0.01% to 0.5% of Mn, 0.002% to 0.040% of one or two selected from S and Se, 0.001% to 0.050% of sol.Al, and 0.0010% to 0.020% of N, the balance being Fe and incidental impurities, is subjected to: hot rolling; hot band annealing as required; subsequent cold rolling once, or twice or more with intermediate annealing therebetween, to obtain a final sheet thickness; subsequent primary recrystallization annealing and the nitriding treatment; and subsequent secondary recrystallization annealing after application of an annealing separator, wherein
   a nitrogen increase ΔN due to the nitriding treatment is 1000 ppm or less and N intensity according to X-ray fluorescence at a steel plate surface is 0.59 or greater.
2. A primary recrystallization annealed sheet for grain-oriented electrical steel sheet production, the primary recrystallization annealed sheet being obtainable after nitriding treatment in a series of steps for grain-oriented electrical steel sheet production in which a steel slab containing, in mass %, 0.001% to 0.10% of C, 1.0% to 5.0% of Si, 0.01% to 0.5% of Mn, 0.002% to 0.040% of one or two selected from S and Se, 0.001% to 0.050% of sol.Al, and 0.0010% to 0.020% of N, the balance being Fe and incidental impurities, is subjected to: hot rolling; hot band annealing as required; subsequent cold rolling once, or twice or more with intermediate annealing therebetween, to obtain a final sheet thickness; subsequent primary recrystallization annealing and the nitriding treatment; and subsequent secondary recrystallization annealing after application of an annealing separator, wherein
   a nitrogen increase ΔN due to the nitriding treatment is 1000 ppm or less and an N intensity peak according to GDS emission analysis at a steel sheet surface is positioned at a surface layer-side of a Si intensity peak.
3. The primary recrystallization annealed sheet for grain-oriented electrical steel sheet production described in 1 or 2, wherein the steel slab further contains, in mass %, one or more selected from 0.005% to 1.50% of Ni, 0.01% to 0.50% of Sn, 0.005% to 0.50% of Sb, 0.01% to 0.50% of Cu, 0.01% to 1.50% of Cr, 0.0050% to 0.50% of P, 0.01% to 0.50% of Mo, 0.0005% to 0.0100% of Nb, 0.0005% to 0.0100% of Ti, 0.0001% to 0.0100% of B, and 0.0005% to 0.0100% of Bi.
4. A method of producing a grain-oriented electrical steel sheet, comprising performing secondary recrystallization annealing using the primary recrystallization annealed sheet for grain-oriented electrical steel sheet production of any one of claims 1, 2, and 3 as a material after applying an annealing separator onto a surface thereof.

We enable simple uniform formation of an inhibitor in a sheet thickness direction during production of a grain-oriented electrical steel sheet by a process in which nitriding is adopted and enables industrially reliable production of grain-oriented electrical steel sheets having good properties.

### BRIEF DESCRIPTION OF THE DRAWINGS

FIG. 1 illustrates an N intensity profile according to GDS.

FIG. 2A is an electron microscope photograph illustrating a resultant steel microstructure when a material that was prepared by producing a decarburization annealed coil from a 3.2% Si slab containing 150 ppm of Al and 30 ppm of N, cutting a test piece from the decarburization annealed coil, and subjecting the test piece to nitriding treatment with a nitrogen increase of 300 ppm and that exhibited an N intensity of 0.65 when a surface state of the material after nitriding was analyzed by X-ray fluorescence, was subjected to annealing in a laboratory for 5 hours at from room temperature to 700° C. and for 2 hours at from 700° C. to 900° C., and was water-cooled directly thereafter.

FIG. 2B illustrates identification results according to EDX (energy dispersive X-ray spectroscopy) for precipitates in the resultant steel microstructure.

FIG. 3A is an electron microscope photograph illustrating a resultant steel microstructure when in production of a decarburization annealed coil from a slab having Al reduced to 50 ppm or less, nitriding treatment was performed after decarburization annealing with a nitrogen increase of 500 ppm, subsequent heating was performed with a heating time of 6 hours at from 300° C. to 700° C. and a heating time of 2 hours at from 700° C. to 800° C., and water-cooling was performed directly thereafter.

FIG. 3B illustrates identification results according to EDX (energy dispersive X-ray spectroscopy) for precipitates in the resultant steel microstructure.

### DETAILED DESCRIPTION

The following provides a specific explanation of our sheets and methods.

We found that it is possible to, in an industrially reliable manner, uniformly disperse a nitride as an inhibitor in a sheet thickness direction during a process for producing a grain-oriented electrical steel sheet in which nitriding is adopted, and thereby obtain good magnetic properties.

We heated a 3.2% Si steel slab containing 150 ppm of Al and 30 ppm of N to 1280° C. and, subsequently, hot rolled the steel slab to form a hot rolled coil of 2.5 mm in thickness. Next, the hot rolled coil was subjected to hot band annealing at 1020° C. and then subjected to cold rolling with a temperature during rolling of 150° C. and an aging time of 1 minute or longer to form a cold rolled coil of 0.23 mm in thickness. Thereafter, the cold rolled coil was subjected to decarburization annealing at 800° C. in a damp atmosphere of mixed hydrogen and nitrogen.

Test pieces were cut from the resultant decarburization annealed coil and subjected to various nitriding treatments. The surface state of each material resulting from nitriding treatment was analyzed by X-ray fluorescence and GDS emission analysis. The treated material was then subjected to particularly short secondary recrystallization annealing in the laboratory with a holding time at 700° C. to 900° C. of 2 hours and, subsequently, subjected to purification annealing at 1150° C. to obtain a grain-oriented electrical steel sheet, the magnetic properties of which were investigated.

As a result, we discovered that an effect of improving magnetic properties increases when a concentrated nitrogen section is present at the outermost surface layer of the steel sheet after the nitriding treatment, and in particular when nitrogen at the steel sheet surface exhibits an N intensity according to X-ray fluorescence of 0.59 or greater or when an N intensity peak according to GDS emission analysis is positioned at a surface layer-side of a Si intensity peak.

The aforementioned X-ray fluorescence analysis result shows that prior to secondary recrystallization, most of the nitrogen supplied through nitriding is present in a high proportion in an outermost surface layer having a depth approximately equivalent to that of X-ray penetration in X-ray fluorescence. The aforementioned GDS emission analysis result shows that nitrogen is present at a surface layer-side of lamellar shaped SiO₂ in a subscale (internal oxidized layer mainly composed of SiO₂) present at the surface of the decarburization annealed sheet. Specifically, we realized that it is important for nitrogen to be present at a different position to the SiO₂ layers present in the subscale. In other words, it is important that nitrogen is present in a surface layer region of silicon steel that is a region of substantially pure iron with low Si concentration.

We discovered that, to create a state in which nitrogen is present as described above, it is necessary to inhibit nitrogen diffusion in the steel by appropriately controlling not only the temperature and time of nitriding treatment, but also by appropriately controlling a cooling stage and temperature hysteresis after the nitriding treatment, which are normally not specifically controlled.

This technique causes a large amount of nitrogen supplied by nitriding to be present in a pure iron layer having low Si concentration created as a result of SiO₂ formation in a subscale at the surface of a decarburization annealed sheet that is to be used for grain-oriented electrical steel sheet production. Accordingly, this technique inhibits precipitation of Si₃N₄ from occurring in advance and creates a state in which the nitrogen can be readily supplied inward into the steel.

Reasons for limiting the chemical composition of the steel slab to the aforementioned ranges will be explained. It should be noted that when components are expressed in “%,” this refers to mass % unless otherwise specified.

### C: 0.001% to 0.10%

C is a useful element to improve primary recrystallized texture and is required to be contained in an amount of 0.001% or greater. Conversely, C content of greater than 0.10% can lead to deterioration in primary recrystallized texture. Therefore, the C content is limited to 0.001% to 0.10%. From the viewpoint of magnetic properties, the preferable C content is 0.01% to 0.06%.

### Si: 1.0% to 5.0%

Si is a useful element to improve iron loss properties by increasing electrical resistance. However, Si content of greater than 5.0% causes significant deterioration of cold rolling manufacturability. Therefore, the Si content is limited to 5.0% or less. On the other hand, Si content of 1.0% or greater is necessary since Si is required to serve as a nitride forming element. Furthermore, from the viewpoint of iron loss properties, the preferable Si content is 1.5% to 4.5%.

### Mn: 0.01% to 0.5%

Mn is a component that exhibits an inhibitor effect by bonding with S or Se to form MnSe or MnS. Mn also has an effect of improving hot workability in production. However, Mn content of less than 0.01% produces inadequate additive effects, whereas Mn content of greater than 0.5% adversely affects primary recrystallized texture and leads to deterioration in magnetics properties. Therefore, the Mn content is limited to 0.01% to 0.5%.

One or Two Selected from S and Se: 0.002% to 0.040% in Total

S and Se are useful components that exhibit an inhibitor effect as a disperse second phase in steel by bonding with Mn or Cu to form MnSe, MnS, Cu₂₋ₓSe, or Cu₂₋ₓS. S and Se content of less than 0.002% produces inadequate additive effects, whereas S and Se content of greater than 0.040% leads incomplete solution formation during slab reheating and is also a cause of product surface defects. Therefore, the S and Se content is limited to 0.002% to 0.040% regardless of whether individual addition or combined addition of S and Se is performed.

### sol.Al: 0.001% to 0.050%

Al is a useful component that exhibits an inhibitor effect as a disperse second phase by forming AlN in steel. Al content of less than 0.001% does not allow a sufficient amount of precipitation, whereas Al content of greater than 0.050% causes excessive precipitation of AlN after nitriding and excessive inhibition of grain growth, and may lead to a troublesome situation in which secondary recrystallization cannot be developed even when annealing is performed to a high temperature. Depending on the balance with the amount of nitrogen, Al content of less than 0.001% may lead to precipitation of non-Al-containing Si₃N₄ after nitriding. Although it is not necessary for a large amount of Al to be contained in a situation in which Si₃N₄ serves as an inhibitor, adding a trace amount of Al during a steelmaking stage has an effect of inhibiting deterioration in properties because the high oxygen affinity of Al itself reduces the amount of dissolved oxygen in the steel, and thus reduces the amount of oxides and inclusions in the steel. Therefore, adding 0.001% or greater of acid-soluble Al can have an effect of inhibiting magnetic deterioration.

### N: 0.0010% to 0.020%

In the same way as Al, N is an essential component to form AlN. Although nitriding treatment in a subsequent process can be used to supply nitrogen that is required as an inhibitor during secondary recrystallization, N content of less than 0.0010% leads to excessive crystal grain growth in annealing processes performed up until the nitriding process and may cause intergranular cracking or the like in the cold rolling process. On the other hand, N content of greater than 0.020% causes blistering or the like to occur during slab reheating. Therefore, the N content is limited to 0.001% to 0.020%.

Note that in a situation in which AlN is actively used as an inhibitor, the sol.Al content is preferably 0.01% or greater and the N content is preferably restricted to less than 14/26.98 of the sol.Al content. This allows fresh precipitation of AlN in nitriding. On the other hand, in a situation in which only Si₃N₄ is actively used as an inhibitor, the N content preferably satisfies sol.Al×14/26.98≦N≦80 ppm while restricting the sol.Al content to less than 0.01%. In a situation in which the sol.Al content and the N content are not in the ranges described above such as a situation in which a slab having a composition containing 0.009% of sol.Al and 0.002% of N is used in production, secondary recrystallization behavior may be destabilized due to a mixed region of AlN and Si₃N₄.

Besides the above components, O content is preferably restricted to less than 50 ppm because O content of 50 ppm or greater causes inclusions such as coarse oxides, hinders rolling processes and leads to a non-uniform primary recrystallization microstructure, and causes deterioration in magnetic properties due to the formed inclusions.

The basic components are as described above. The following elements may be contained according to necessity as components to improve magnetic properties in an even more industrially reliable manner.

### Ni: 0.005% to 1.50%

Ni provides an effect of improving magnetic properties by enhancing the uniformity of microstructure of the hot rolled sheet and, to obtain this effect, Ni is preferably contained in an amount of 0.005% or greater. On the other hand, if the Ni content is greater than 1.50%, it becomes difficult to develop secondary recrystallization, and magnetic properties deteriorate. Therefore, the Ni content is preferably 0.005% to 1.50%.

### Sn: 0.01% to 0.50%

Sn is a useful element that improves magnetic properties by suppressing nitridation and oxidization of the steel sheet during secondary recrystallization annealing and facilitating secondary recrystallization of crystal grains having good crystal orientation. The Sn content is preferably 0.01% or greater to obtain this effect, but cold rolling manufacturability deteriorates if the Sn content is greater than 0.50%. Therefore, the Sn content is preferably 0.01% to 0.50%.

### Sb: 0.005% to 0.50%

Sb is a useful element that effectively improves magnetic properties by suppressing nitridation and oxidization of the steel sheet during secondary recrystallization annealing and facilitating secondary recrystallization of crystal grains having good crystal orientation. The Sb content is preferably 0.005% or greater to obtain this effect, but cold rolling manufacturability deteriorates if the Sb content is greater than 0.50%. Therefore, the Sb content is preferably 0.005% to 0.50%.

### Cu: 0.01% to 0.50%

Cu provides an effect of effectively improving magnetic properties by suppressing oxidization of the steel sheet during secondary recrystallization annealing and facilitating secondary recrystallization of crystal grains having good crystal orientation. The Cu content is preferably 0.01% or greater to obtain this effect, but hot rolling manufacturability deteriorates if the Cu content is greater than 0.50%. Therefore, the Cu content is preferably 0.01% to 0.50%.

### Cr: 0.01% to 1.50%

Cr provides an effect of stabilizing formation of forsterite films. The Cr content is preferably 0.01% or greater to obtain this effect, but it becomes difficult to develop secondary recrystallization, and magnetic properties deteriorate, if the Cr content is greater than 1.50%. Therefore, the Cr content is preferably 0.01% to 1.50%.

### P: 0.0050% to 0.50%

P provides an effect of stabilizing formation of forsterite films. The P content is preferably 0.0050% or greater to obtain this effect, but cold rolling manufacturability deteriorates if the P content is greater than 0.50%. Therefore, the P content is preferably 0.0050% to 0.50%.

### Mo: 0.01% to 0.50%, Nb: 0.0005% to 0.0100%

Mo and Nb both have an effect of suppressing generation of scabs after hot rolling by, for example, suppressing cracks caused by temperature change during slab reheating. These elements become less effective in suppressing scabs, however, unless the Mo content is 0.01% or greater and the Nb content is 0.0005% or greater. On the other hand, if the Mo content is greater than 0.50% and the Nb content is greater than 0.0100%, Mo and Nb cause deterioration of iron loss properties if they remain in the finished product as, for example, a carbide or a nitride. Therefore, it is preferable for the Mo content and the Nb content to be in the aforementioned ranges.

### Ti: 0.0005% to 0.0100%, B: 0.0001% to 0.0100%, Bi: 0.0005% to 0.0100%

Ti, B, and Bi may form precipitates or may themselves segregate during nitriding and have an effect of stabilizing secondary recrystallization by serving as auxiliary inhibitors. However, the effect as auxiliary inhibitors is inadequately obtained if the Ti, B, and Bi contents are below their lower limits. On the other hand, the formed precipitates may remain after purification if the Ti, B, and Bi contents are greater than their upper limits, which may cause deterioration of magnetic properties, and also deterioration of bending properties through embrittlement of grain boundaries. Accordingly, the Ti, B, and Bi contents are preferably in the respective ranges specified above.

The following describes a presently disclosed production method.

A steel slab adjusted to the above preferable chemical composition range is subjected to hot rolling without being reheated or after being reheated. When reheating the slab, the reheating temperature is preferably approximately 1000° C. to 1350° C. In other words, in the production method, it is not necessary to perform slab reheating to an extremely high temperature exceeding 1350° C. because nitriding treatment is performed before secondary recrystallization annealing to reinforce inhibitors such that it is not necessary to achieve fine dispersion of precipitates by complete dissolution in a hot rolling process. However, it is necessary to dissolve and disperse Al, N, Mn, S, and Se to a certain extent in hot rolling so that the crystal grain size does not become excessively coarse in the annealing processes up until nitriding is performed. Moreover, if the reheating temperature is too low, the rolling temperature during hot rolling is also lower, which makes rolling difficult because a heavier rolling load is required. Therefore, the reheating temperature is required to be 1000° C. or higher.

Next, the hot rolled sheet is subjected to hot band annealing as necessary, and is subsequently subjected to cold rolling once, or twice or more with intermediate annealing performed therebetween, to obtain a final cold rolled sheet. The cold rolling may be performed at room temperature. Alternatively, warm rolling where rolling is performed with the steel sheet temperature raised to a temperature higher than room temperature, for example, roughly 250° C. is also applicable.

Thereafter, the final cold rolled sheet is subjected to primary recrystallization annealing. The purpose of primary recrystallization annealing is to cause the cold rolled sheet having a rolled microstructure to undergo primary recrystallization with a primary recrystallization grain size optimally adjusted for secondary recrystallization. To do so, it is preferable to set the annealing temperature of primary recrystallization annealing of approximately 800° C. to below 950° C. Decarburization annealing may be carried out in conjunction with the primary recrystallization annealing by adopting a wet hydrogen-nitrogen atmosphere or a wet hydrogen-argon atmosphere as an annealing atmosphere during the annealing.

Nitriding treatment is performed during or after the above primary recrystallization annealing. No specific limitations are placed on the nitriding method so long as the amount of nitriding can be controlled. For example, as performed in the past, gas nitriding may be performed directly in the form of a coil using NH₃ atmosphere gas, or continuous gas nitriding may be performed on a running strip. It is also possible to utilize salt bath nitriding, which has higher nitriding ability than gas nitriding.

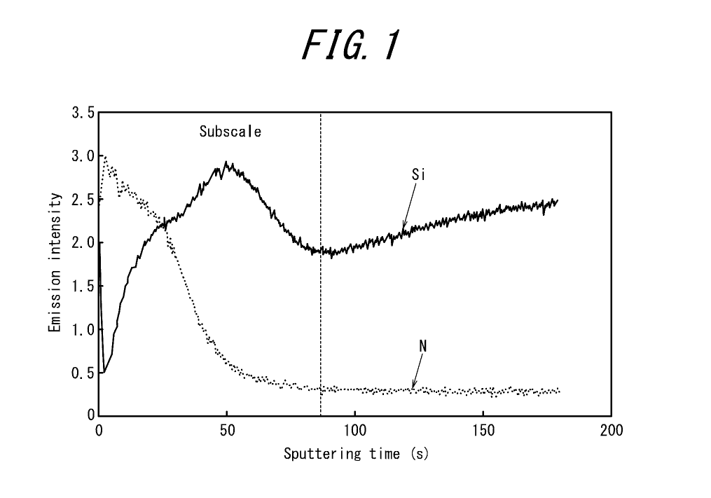

It is important that nitriding is performed in a manner such that a concentrated layer of nitrogen is formed at the surface and such that nitrogen supplied in a thickness range of an outermost surface layer, which is positioned at a surface layer-side of a SiO₂ lamellar layer in a subscale at the surface of the steel sheet, remains in the aforementioned thickness range. In a situation in which most of the nitrogen supplied by through nitriding is present at the steel sheet surface, an intensity of 0.59 or greater is obtained in nitrogen measurement according to X-ray fluorescence (ZSX-Primus II produced by Rigaku Corporation) and an N intensity profile according to GDS (Glow Discharge Spectrometer SYSTEM 3860 produced by Rigaku Corporation) has an N intensity peak positioned at a surface layer-side of a Si intensity peak as shown in FIG. 1. The position of each of the aforementioned peaks in GDS is taken to be the value at a maximum in a profile of the corresponding element obtained by performing sputtering (to a depth of approximately 6 μm) for 180 s with intervals of 200 ms under conditions of a measurement current of 20 mA and Ar gas flow of 250 ml/min in constant current mode.

To create a state such as described above, the nitriding treatment is, in particular, preferably performed at a temperature of 600° C. or lower to suppress inward diffusion of nitrogen in the steel. Note that even in a situation in which the nitriding temperature is greater than 600° C., it is still possible to increase the N intensity near the surface by shortening the treatment time. A suitable nitriding treatment time should be set as appropriate depending on the nitriding temperature and the potential with which nitriding is performed, which is explained further below. In actual operation, it is preferable to aim for a short operation time of 10 minutes or less.

However, there are many cases in which this is not sufficient for achieving results that satisfy our conditions, namely that nitrogen intensity according to X-ray fluorescence is 0.59 or greater and that the N peak is positioned at the surface-layer side of the Si peak in GDS. To achieve results satisfying these conditions, it is important that cooling is performed to 200° C. or lower within 24 hours after the nitriding treatment to restrict the time for diffusion across the entire process. In a situation in which a coil is subjected to nitriding treatment in that form or a coil shape is wound after nitriding treatment, the inside of the coil retains a relatively high temperature since the internal temperature of the coil has a low tendency to decrease, which causes nitrogen to diffuse inward in the steel from the steel sheet surface and makes it difficult to retain most of the nitrogen at the steel sheet surface.

Gas nitriding and salt bath nitriding are not the only methods by which nitriding can be performed and various other methods are used in industry such as gas nitrocarburizing and plasma nitriding. Our primary recrystallization annealed sheet can be obtained using gas nitriding or salt bath nitriding by performing the nitriding treatment under the production conditions described above. However, it may be possible to realize the same through various conditions other than the conditions considered herein by considering, for example, modification of the surface layer state of the steel sheet that is to be subjected to nitriding, the potential with which nitriding is performed (for example, the concentration of NH₃ relative to H₂ in gas nitriding and the type of salt used in salt bath nitriding), or a completely different nitriding method.

We discovered that to use a nitride as an inhibitor through nitriding and form a uniform precipitation state in the sheet thickness direction when using the aforementioned nitride, it is extremely useful for the primary recrystallization annealed sheet after nitriding and prior to secondary recrystallization to have a surface state in which N intensity according to X-ray fluorescence is 0.59 or greater and in which an N intensity peak is positioned at a surface layer-side of a Si intensity peak according to GDS emission analysis results. Hence this disclosure is not limited to the production conditions described above with regard to the nitriding method and the nitriding conditions.

Furthermore, the nitrogen increase (ΔN) due to nitriding is preferably 50 ppm or greater, and is required to be restricted to an upper limit of 1000 ppm. A small nitrogen increase leads to an inadequate inhibitor reinforcement effect, whereas a large nitrogen increase causes poor secondary recrystallization as a result of grain growth inhibition being excessively high.

After the primary recrystallization annealing and the nitriding treatment, an annealing separator is applied onto the surface of the steel sheet prior to performing secondary recrystallization annealing. It is necessary to use an annealing separator mainly composed of magnesia (MgO) to form a forsterite film on the surface of the steel sheet after secondary recrystallization annealing. However, if there is no need to form a forsterite film, any suitable oxide having a melting point higher than the secondary recrystallization annealing temperature such as alumina (Al₂O₃) or calcia (CaO) can be used as the main component of the annealing separator.

Subsequently, secondary recrystallization annealing is performed. The concentrated nitrogen layer at the surface decomposes during a heating stage of the secondary recrystallization annealing, causing N to diffuse inward in the steel.

Our primary recrystallization annealed sheet is in a state in which nitrogen is concentrated near the outermost surface layer, which is at the surface layer-side of a SiO₂ lamellar layer in the subscale. Si bonds to oxygen to form SiO₂ in the subscale such that a pure iron layer is present at the periphery thereof. Moreover, once Si has formed SiO₂, it seems unlikely that the Si will then newly bond to nitrogen because SiO₂ is an extremely stable substance compared to Si₃N₄, and thus a characteristic effect is achieved of nitrogen present in the subscale being unlikely to be fixed as Si₃N₄. Even supposing that nitrogen at the outermost surface were to form a nitride rather than dissolving, we believe that this nitride would be an iron-based nitride because Si is not present around the nitrogen. Representative iron-based nitrides are all thermodynamically unstable compared to Si₃N₄, which means that they readily decompose at a lower temperature, thereby allowing diffusion inward in the steel to occur from a stage right at the start of secondary recrystallization annealing.

In other words, in the context of the conventional series of behavior in which diffusion of N solute starts once the temperature at which Si₃N₄ decomposes or dissolves is reached and, subsequently, an Al-containing nitride precipitates, N diffusion can start at the same time as annealing starts if N does not pass through Si₃N₄ as an initial state. Moreover, if N forms a less stable nitride than Si₃N₄, diffusion of N can start once a temperature is reached at which the less stable nitride decomposes or dissolves.

Accordingly, we take advantage of the phenomenon described above to enable shortening of the heating time in secondary recrystallization annealing. Specifically, the holding time at 700° C. to 900° C. can be shortened to 2 hours or less. We believe that is possible due to the range of temperatures that assist N diffusion starting from a lower temperature. Naturally, a uniform precipitation state in the sheet thickness direction can be implemented in the same way even if the holding time at 700° C. to 900° C. is the same as that conventionally used. Although it is difficult to perform rapid heating in the same way as in the laboratory using actual production equipment that implements coil annealing, use of our method enables compatibility with heating for a short time, and thus can allow shortening of the annealing time and reduction of production costs. In coil annealing, even if it is expected that sufficient holding time will be ensured, a situation may arise in which the heating rate of a section close to a heat source increases such that the expected holding time is not ensured in practice. However, this type of situation can also be dealt with by adopting the present method. The above description is for a situation in which AlN or (Al,Si)N is used as an inhibitor.

However, we also enable uniform dispersion in the sheet thickness direction in a situation in which Si₃N₄ is used as an inhibitor. In Si₃N₄, behavior at temperatures of 800° C. or lower is important because the precipitation temperature of Si₃N₄ is lower than that of AlN and (Al,Si)N. Adoption of our technique enables nitrogen diffusion in the sheet thickness direction to start from a lower temperature in the same way as described further above.

Si₃N₄ has poor matching with the crystal lattice of steel (i.e., the misfit ratio is high) and, therefore the precipitation rate is typically very low at low temperatures. Specifically, it is very difficult to cause precipitation to occur in a time frame of the order of several hours at 600° C. or lower. Accordingly, a temperature of 700° C. to 800° C. is necessary for precipitation of Si₃N₄ to proceed.

We enable nitrogen diffusion to occur to near a sheet thickness central layer before precipitation starts because, in the heating stage of the secondary recrystallization annealing, nitrogen diffusion in the steel starts in a low temperature range of 600° C. or lower. It is necessary for the holding time in a temperature region of roughly 300° C. to 700° C. to be 5 hours or longer to achieve this. Uniform dispersion in the sheet thickness direction cannot be achieved in a shorter period of time because diffusion cannot sufficiently proceed in this time. On the other hand, although it is not necessary to set a specific upper limit for the holding time, the holding time is preferably kept short in the same way as when AlN or Al,Si)N is used because a holding time longer than necessary merely leads to increased production costs. Furthermore, N₂, Ar, H₂ or a mixed gas thereof may be adopted as the annealing atmosphere.

Accordingly, a grain-oriented electrical steel sheet produced through the processes described above using our primary recrystallization annealed sheet as a material can be provided with good magnetic properties because a nitride can be caused to precipitate uniformly in the sheet thickness direction in the heating stage of the secondary recrystallization annealing and in a stage up until the secondary recrystallization begins.

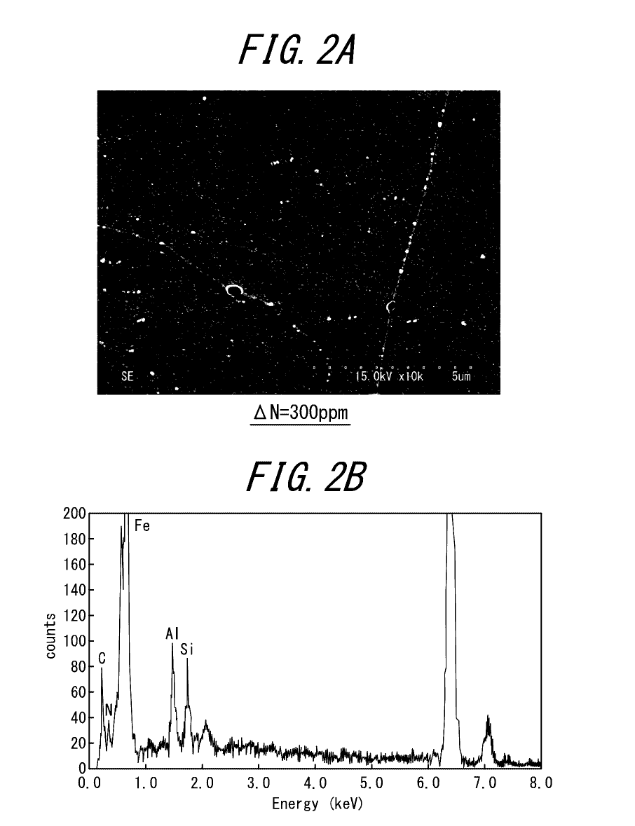

A material that was prepared by producing a decarburization annealed coil from a 3.2% Si slab containing 150 ppm of Al and 30 ppm of N, cutting a test piece from the decarburization annealed coil, and subjecting the test piece to nitriding treatment with a nitrogen increase of 300 ppm and that exhibited fluorescence X-ray N intensity of 0.65 when a surface state thereof after nitriding was analyzed by X-ray fluorescence, was subjected to annealing in a laboratory for 5 hours at from room temperature to 700° C. and for 2 hours at from 700° C. to 900° C., and was water-cooled directly thereafter. The resultant steel microstructure was observed using an electron microscope and the composition of precipitates was identified. FIG. 2A is an electron microscope photograph of the aforementioned steel microstructure and FIG. 2B illustrates identification results according to EDX.

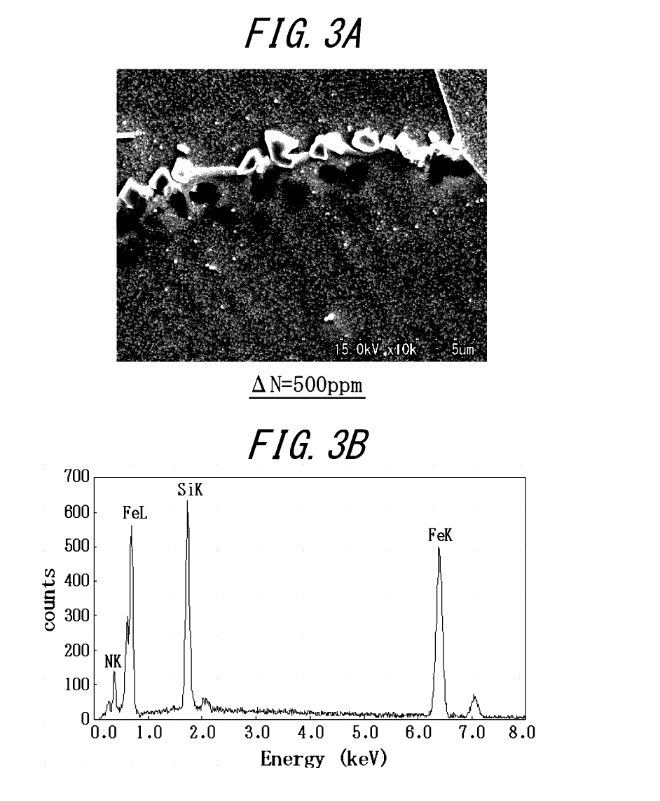

A decarburization annealed coil produced from a slab having Al reduced to 50 ppm or less was subsequently subjected to nitriding treatment to obtain a nitrogen increase of 500 ppm, was subsequently heated with a heating time of 6 hours at 300° C. to 700° C. and a heating time of 2 hours at 700° C. to 800° C., and water-cooled directly thereafter. The resultant steel microstructure was observed using an electron microscope and identification was performed. FIG. 3A is an electron microscope photograph of the aforementioned steel microstructure and FIG. 3B illustrates identification according to EDX.

Observations were made at a sheet thickness central section in each of the above cases and the presence of (Al,Si)N or Si₃N₄ precipitation was confirmed in both. In particular, large amounts of (Al,Si)N and Si₃N₄ precipitates were observed at grain boundaries when our method was adopted. In terms of precipitation state, precipitates having a size of approximately 100 nm or less had a high frequency in the case of (Al,Si)N and precipitates having a size of 300 nm or greater had a high frequency in the case of Si₃N₄.

In production, it is clear that utilizing the heating process of secondary recrystallization after nitriding treatment is most effective for precipitation of nitrides in terms of energy efficiency, yet it is also possible to precipitate nitrides by utilizing a similar heat cycle. Therefore, it is also possible to implement nitride dispersing annealing before time consuming secondary recrystallization annealing in production.

After the above secondary recrystallization annealing, it is possible to further apply and bake an insulation coating on the surface of the steel sheet. Such an insulation coating is not limited to a particular type, and any conventionally known insulation coating is applicable. For example, preferred methods are described in JP S50-79442 A and JP S48-39338 A where a coating liquid containing phosphate-chromate-colloidal silica is applied on a steel sheet and then baked at a temperature of around 800° C.

It is possible to correct the shape of the steel sheet by flattening annealing, and to further combine the flattening annealing with baking treatment of the insulation coating.

### EXAMPLES

### Example 1

A steel slab containing 3.25% of Si, 0.05% of C, 0.08% of Mn, 0.003% of S, amounts of Al and N shown in Table 1, and amounts of other components such as Ni, Sn, Sb, Cu, Cr, P, Mo, and Nb shown in Table 1 was heated for 30 minutes at 1150° C. and hot rolled to form a hot rolled sheet of 2.2 mm in thickness. Next, the hot rolled sheet was subjected to hot band annealing for 1 minute at 1000° C. and then cold rolled to a final sheet thickness of 0.27 mm. A sample of 100 mm×400 mm in size was taken from a central part of a resultant cold rolled coil and subjected to annealing combining primary recrystallization and decarburization in a laboratory.

The sample was then subjected to nitriding treatment (batch treatment; nitriding treatment by salt bath using a salt composed mainly of cyanate or nitriding treatment using a mixed gas of NH₃ and N₂) under the conditions shown in Table 1 to increase the amount of nitrogen in the steel. The nitrogen increase ΔN was quantified through chemical analysis with the entire depth of the sheet as a target.

10 steel sheets were prepared under the same conditions for each of a plurality of sets of conditions. An annealing separator containing MgO as a main component and 5% of TiO₂ was applied onto each of the steel sheets as a water slurry, dried and baked on the steel sheet, and final annealing performed at 700° C. to 900° C. for 4 hours. Thereafter, a phosphate-based insulating tension coating was applied and baked.

Table 2 shows results obtained upon investigating the nitrogen increase ΔN after the nitriding treatment, the N intensity according to X-ray fluorescence after the nitriding treatment, N and Si peak times measured by GDS, and a magnetic property B₈ (T). The magnetic property was evaluated as an average value of the 10 sheets for each set of conditions, whereas other evaluations were made by measuring a single representative sample.

TABLE 1

| | | | | Nitriding treatment conditions | | | Cooling | |
|---|---|---|---|---|---|---|---|---|
| | Slab composition (nitriding-related components) | | | | Treatment | | time to | |
| | Al | N | Other | Treatment | temperature | Treatment | 200° C. | |
| | (ppm) | (ppm) | (mass %) | method | (° C.) | time (s) | (h) | Remarks |
| Condition 1 | 150 | 30 | Ni: 0.02, Sb: 0.02, Cr: 0.05, P: 0.05 | None | — | — | — | Comparative example |
| Condition 2 | 150 | 30 | Ni: 0.02, Sb: 0.02, Cr: 0.05, P: 0.05 | Gas nitriding | 600 | 60 | 50 | Comparative example |
| Condition 3 | 150 | 30 | Ni: 0.02, Sb: 0.02, Cr: 0.05, P: 0.05 | Gas nitriding | 600 | 60 | 30 | Comparative example |
| Condition 4 | 150 | 30 | Ni: 0.02, Sb: 0.02, Cr: 0.05, P: 0.05 | Gas nitriding | 600 | 60 | 25 | Comparative example |
| Condition 5 | 150 | 30 | Ni: 0.02, Sb: 0.02, Cr: 0.05, P: 0.05 | Gas nitriding | 600 | 60 | 20 | Example |
| Condition 6 | 150 | 30 | Ni: 0.02, Sb: 0.02, Cr: 0.05, P: 0.05 | Gas nitriding | 600 | 60 | 12 | Example |
| Condition 7 | 80 | 40 | — | None | — | — | — | Comparative example |
| Condition 8 | 80 | 40 | — | Gas nitriding | 650 | 60 | 20 | Comparative example |
| Condition 9 | 80 | 40 | — | Gas nitriding | 580 | 240 | 20 | Example |
| Condition 10 | 60 | 35 | Sn: 0.01, Cu: 0.06 | None | — | — | — | Comparative example |
| Condition 11 | 60 | 35 | Sn: 0.01, Cu: 0.06 | Salt bath nitriding | 480 | 30 | 0.5 | Comparative example |
| Condition 12 | 60 | 35 | Sn: 0.01, Cu: 0.06 | Salt bath nitriding | 480 | 420 | 0.5 | Example |
| Condition 13 | 60 | 35 | Sn: 0.01, Cu: 0.06 | Salt bath nitriding | 480 | 600 | 0.5 | Comparative example |
| Condition 14 | 90 | 20 | Sn: 0.01, Cu: 0.06 | Salt bath nitriding | 520 | 320 | 1 | Example |
| Condition 15 | 130 | 80 | Sn: 0.01, Cu: 0.06 | Salt bath nitriding | 520 | 350 | 1 | Example |
| Condition 16 | 85 | 25 | P: 0.05, Mo: 0.05, Nb: 0.0001 | None | — | — | — | Comparative example |
| Condition 17 | 85 | 25 | P: 0.05, Mo: 0.05, Nb: 0.0001 | Salt bath nitriding | 480 | 30 | 0.5 | Comparative example |
| Condition 18 | 85 | 25 | P: 0.05, Mo: 0.05, Nb: 0.0001 | Salt bath nitriding | 480 | 420 | 0.5 | Example |
| Condition 19 | 85 | 25 | P: 0.05, Mo: 0.05, Nb: 0.0001 | Salt bath nitriding | 480 | 600 | 0.5 | Comparative example |
| Condition 20 | 85 | 25 | — | None | — | — | 0.5 | Comparative example |
| Condition 21 | 85 | 25 | — | Salt bath nitriding | 480 | 420 | 0.5 | Example |
| Condition 22 | 85 | 25 | Sb: 0.03, Cu: 0.05 | Salt bath nitriding | 480 | 420 | 0.5 | Example |
| Condition 23 | 180 | 30 | Ni: 0.01 | None | — | — | — | Comparative example |
| Condition 24 | 180 | 30 | Ni: 0.01 | Salt bath nitriding | 650 | 5 | 0.5 | Comparative example |
| Condition 25 | 180 | 30 | Ni: 0.01 | Salt bath nitriding | 450 | 30 | 0.5 | Example |
| Condition 26 | 180 | 30 | Ni: 0.01 | Salt bath nitriding | 580 | 20 | 0.5 | Example |
| Condition 27 | 50 | 30 | P: 0.05, Sb: 0.03 | None | — | — | — | Comparative example |
| Condition 28 | 50 | 30 | P: 0.05, Sb: 0.03 | Gas nitriding | 600 | 50 | 50 | Comparative example |
| Condition 29 | 50 | 30 | P: 0.05, Sb: 0.03 | Gas nitriding | 600 | 50 | 24 | Example |
| Condition 30 | 50 | 30 | P: 0.05, Sb: 0.03 | Gas nitriding | 600 | 50 | 10 | Example |

TABLE 2

| | Nitrogen | | | | Magnetic | |
|---|---|---|---|---|---|---|
| | increase | X-ray | GDS peak | | property | |
| | ΔN | fluorescence | time (s) | | B₈ | |
| | (ppm) | N intensity | N | Si | (T) | Remarks |
| Condition 1 | 0 | 0.38 | — | 55 | 1.863 | Comparative example |
| Condition 2 | 280 | 0.49 | 65 | 60 | 1.896 | Comparative example |
| Condition 3 | 290 | 0.51 | 70 | 55 | 1.882 | Comparative example |
| Condition 4 | 270 | 0.55 | 70 | 60 | 1.900 | Comparative example |
| Condition 5 | 280 | 0.63 | 15 | 60 | 1.927 | Example |
| Condition 6 | 260 | 0.66 | 10 | 55 | 1.925 | Example |
| Condition 7 | 0 | 0.37 | — | 50 | 1.853 | Comparative example |
| Condition 8 | 410 | 0.51 | 80 | 45 | 1.900 | Comparative example |
| Condition 9 | 350 | 0.62 | 10 | 50 | 1.919 | Example |
| Condition 10 | 0 | 0.38 | — | 65 | 1.861 | Comparative example |
| Condition 11 | 30 | 0.39 | — | 60 | 1.864 | Comparative example |
| Condition 12 | 500 | 0.68 | 5 | 65 | 1.925 | Example |
| Condition 13 | 1100 | 0.79 | 5 | 65 | 1.794 | Comparative example |
| Condition 14 | 710 | 0.71 | 10 | 65 | 1.913 | Example |
| Condition 15 | 780 | 0.74 | 5 | 55 | 1.917 | Example |
| Condition 16 | 0 | 0.36 | — | 70 | 1.872 | Comparative example |
| Condition 17 | 40 | 0.39 | — | 65 | 1.875 | Comparative example |
| Condition 18 | 520 | 0.62 | 5 | 65 | 1.918 | Example |
| Condition 19 | 1050 | 0.78 | 5 | 70 | 1.799 | Comparative example |
| Condition 20 | 0 | 0.35 | — | 70 | 1.866 | Comparative example |
| Condition 21 | 490 | 0.63 | 5 | 70 | 1.916 | Example |
| Condition 22 | 510 | 0.65 | 5 | 65 | 1.924 | Example |
| Condition 23 | 0 | 0.35 | — | 45 | 1.810 | Comparative example |
| Condition 24 | 50 | 0.52 | 55 | 50 | 1.897 | Comparative example |
| Condition 25 | 50 | 0.59 | 5 | 45 | 1.913 | Example |
| Condition 26 | 90 | 0.60 | 15 | 50 | 1.922 | Example |
| Condition 27 | 0 | 0.38 | — | 55 | 1.873 | Comparative example |
| Condition 28 | 200 | 0.49 | 65 | 60 | 1.899 | Comparative example |
| Condition 29 | 220 | 0.61 | 15 | 55 | 1.916 | Example |
| Condition 30 | 200 | 0.65 | 10 | 60 | 1.911 | Example |

As shown in Table 2, we demonstrated that the magnetic property was improved in our Examples compared to the Comparative Examples.

1-4. (canceled)

5. A primary recrystallization annealed sheet for grain-oriented electrical steel sheet production, the primary recrystallization annealed sheet being obtainable after nitriding treatment in a series of steps for grain-oriented electrical steel sheet production in which a steel slab containing, in mass %, 0.001% to 0.10% of C, 1.0% to 5.0% of Si, 0.01% to 0.5% of Mn, 0.002% to 0.040% of one or two selected from S and Se, 0.001% to 0.050% of sol.Al, and 0.0010% to 0.020% of N, the balance being Fe and incidental impurities, is subjected to: hot rolling; hot band annealing as required; subsequent cold rolling once or twice or more with intermediate annealing therebetween to obtain a final sheet thickness; subsequent primary recrystallization annealing and the nitriding treatment; and subsequent secondary recrystallization annealing after application of an annealing separator, wherein
a nitrogen increase ΔN due to the nitriding treatment is 1000 ppm or less and N intensity according to X-ray fluorescence at a steel plate surface is 0.59 or greater.

6. A primary recrystallization annealed sheet for grain-oriented electrical steel sheet production, the primary recrystallization annealed sheet being obtainable after nitriding treatment in a series of steps for grain-oriented electrical steel sheet production in which a steel slab containing, in mass %, 0.001% to 0.10% of C, 1.0% to 5.0% of Si, 0.01% to 0.5% of Mn, 0.002% to 0.040% of one or two selected from S and Se, 0.001% to 0.050% of sol.Al, and 0.0010% to 0.020% of N, the balance being Fe and incidental impurities, is subjected to: hot rolling; hot band annealing as required; subsequent cold rolling once or twice or more with intermediate annealing therebetween to obtain a final sheet thickness; subsequent primary recrystallization annealing and the nitriding treatment; and subsequent secondary recrystallization annealing after application of an annealing separator, wherein
a nitrogen increase ΔN due to the nitriding treatment is 1000 ppm or less and a N intensity peak according to GDS emission analysis at a steel sheet surface is positioned at a surface layer-side of a Si intensity peak.

7. The primary recrystallization annealed sheet production of claim 5, wherein
the steel slab further contains, in mass %, one or more selected from 0.005% to 1.50% of Ni, 0.01% to 0.50% of Sn, 0.005% to 0.50% of Sb, 0.01% to 0.50% of Cu, 0.01% to 1.50% of Cr, 0.0050% to 0.50% of P, 0.01% to 0.50% of Mo, 0.0005% to 0.0100% of Nb, 0.0005% to 0.0100% of Ti, 0.0001% to 0.0100% of B, and 0.0005% to 0.0100% of Bi.

8. A method of producing a grain-oriented electrical steel sheet comprising:
performing secondary recrystallization annealing using the primary recrystallization annealed sheet of claim 5 as a material after applying an annealing separator onto a surface thereof.

9. The primary recrystallization annealed sheet of claim 6, wherein
the steel slab further contains, in mass %, one or more selected from 0.005% to 1.50% of Ni, 0.01% to 0.50% of Sn, 0.005% to 0.50% of Sb, 0.01% to 0.50% of Cu, 0.01% to 1.50% of Cr, 0.0050% to 0.50% of P, 0.01% to 0.50% of Mo, 0.0005% to 0.0100% of Nb, 0.0005% to 0.0100% of Ti, 0.0001% to 0.0100% of B, and 0.0005% to 0.0100% of Bi.

10. A method of producing a grain-oriented electrical steel sheet comprising:
performing secondary recrystallization annealing using the primary recrystallization annealed sheet of claim 6 as a material after applying an annealing separator onto a surface thereof.

11. A method of producing a grain-oriented electrical steel sheet comprising:
performing secondary recrystallization annealing using the primary recrystallization annealed sheet of claim 7 as a material after applying an annealing separator onto a surface thereof.

12. A method of producing a grain-oriented electrical steel sheet comprising:
performing secondary recrystallization annealing using the primary recrystallization annealed sheet of claim 9 as a material after applying an annealing separator onto a surface thereof.
